(19) United States
(12) Patent Application Publication
(10) Pub. No.: US 2015/0356732 A1
(43) Pub. Date: Dec. 10, 2015

(54) IMAGE DISPLAY DEVICE AND METHOD

(71) Applicant: FUJIFILM CORPORATION, Tokyo (JP)

(72) Inventor: Wataru FUKUDA, Ashigarakami-gun (JP)

(73) Assignee: FUJIFILM CORPORATION, Tokyo (JP)

(21) Appl. No.: 14/830,877

(22) Filed: Aug. 20, 2015

Related U.S. Application Data
(63) Continuation of application No. PCT/JP2014/055353, filed on Mar. 4, 2014.

(30) Foreign Application Priority Data
Mar. 22, 2013 (JP) 2013-059259

(51) Int. Cl. G06T 7/00

(52) U.S. Cl. CPC G06T 7/0012; G06T 2210/41; G06T 2207/30068; G06T 2207/10072

(57) ABSTRACT

Provided is a technique which can easily identify a plurality of radiological images when the plurality of radiological images are displayed so as to be switched. A display control unit displays a plurality of radiological images, such as the latest breast image and a past breast image, on a display unit so as to be switched. An identification information display unit displays, on the display unit, identification information for identifying a radiological image which is being displayed on the display unit and radiological images other than the radiological image which is being displayed. A display position control unit controls the display position of the identification information such that the identification information is moved in the vicinity of, for example, an area of interest.

### CROSS-REFERENCE TO RELATED APPLICATIONS

This application is a Continuation of PCT International Application No. PCT/JP2014/055353 filed on Mar. 4, 2014, which claims priority under 35 U.S.C §119 (a) to Japanese Patent Application No. 2013-059259 filed on Mar. 22, 2013. Each of the above application(s) is hereby expressly incorporated by reference, in its entirety, into the present application.

### BACKGROUND OF THE INVENTION

1. Field of the Invention

The present invention relates to an image display device and method which displays, for example, a radiological image of the breast.

2. Description of the Related Art

Comparative reading has been performed which displays a plurality of images of a photographic subject on a display device, such as a CRT or a liquid crystal display, and reads the images while comparing the images. For example, the current and past radiological images of the same part of a patient who is the photographic subject are displayed and comparative reading is performed for medical diagnosis to check the progress of a lesion or to find abnormalities in an early stage. A technique has been known which displays radiological images on a display device in order to facilitate the comparative reading. For example, JP2006-6435A and JP2012-235807A disclose a method which displays a plurality of radiological images for comparative reading on one screen so as to be switched. As such, when the radiological images to be compared are displayed so as to be switched, it is easy to check a changed part, which makes it possible to easily perform comparative reading.

In addition, a method has been proposed in which, during the display of a plurality of tomographic images captured by a CT device or a tomosynthesis device, when a marker is attached to the image of a given tomographic plane, sub-markers are automatically set to the tomographic images of the tomographic planes adjacent to the given tomographic plane, which makes it easy to see the tomographic images (see JP2009-50366A).

### SUMMARY OF THE INVENTION

However, a plurality of radiological images to be comparatively read are similar to each other since they are of the same part of the same patient. Therefore, when a plurality of radiological images are displayed so as to be switched by the methods disclosed in JP2006-6435A and JP2012-235807A, in some cases, it is difficult to know whether the image which is being displayed is the latest image or a past image. In this case, supplementary information, such as the imaging date and time, can be attached to a position which does not hinder reading, such as the edge of the radiological image, which makes it possible to check the imaging date and time, if necessary. However, since the comparative reading is performed while paying attention to an area of interest, such as a lesion, it is very difficult to move the eyes to the corner of the radiological image while paying attention to the area of interest in the images which are displayed so as to be switched.

In addition, when a plurality of tomographic images are displayed, the method disclosed in JP2009-50366A is used to attach the marker to a given tomographic plane. However, when a plurality of tomographic images are displayed so as to be switched as in the methods disclosed in JP2006-6435A and JP2012-235807A, in some cases, it is difficult to know which image of a tomographic plane is currently being displayed. In this case, a method is considered which displays information indicating the tomographic plane of the tomographic image, which is being displayed, at the end of the tomographic image. However, in this method, it is also very difficult to move the eyes to the corner of the tomographic image while paying attention to the area of interest in the images which are displayed so as to be switched.

The invention has been made in view of the above-mentioned problems and an object of the invention is to provide a technique which can easily identify a plurality of radiological images when the plurality of radiological images are displayed so as to be switched.

According to an aspect of the invention, there is provided an image display device including a display control unit that displays a plurality of radiological images on a display unit so as to be switched, an identification information display unit that displays, on the display unit, identification information for identifying a radiological image which is being displayed on the display unit and radiological images other than the radiological image which is being displayed; and a display position control unit that controls a display position of the identification information.

The “identification information” may be any information as long as it can identify the radiological image which is being displayed and the other radiological images. For example, information, such as a mark, an icon, letters, the color of a frame of a window for displaying the radiological image, the width of the frame, and the line type of the frame, can be used as the identification information.

In the image display device according to the above-mentioned aspect of the invention, the plurality of radiological images may be radiological images of the same photographic subject which are captured at different dates and times. The display control unit may display the radiological images with different imaging dates and times so as to be switched. The identification information display unit may display identification information which can identify the radiological images with different imaging dates and times.

For example, markers having colors or shapes which vary depending on the imaging date and time, markers which are assigned or not assigned depending on the imaging date and time, and letters indicating the imaging date and time can be used as the “identification information which can identify the radiological images different imaging dates and times”.

In the image display device according to the above-mentioned aspect of the invention, the plurality of radiological images may be tomographic images of a plurality of tomographic planes for the same photographic subject. The display control unit may display the tomographic images of different tomographic planes so as to be switched. The identification information display unit may display identification information which can identify the tomographic planes.

In the image display device according to the above-mentioned aspect of the invention, the display position control unit may display the identification information in the vicinity of an area of interest in the radiological image.

In the image display device according to the above-mentioned aspect of the invention, the display control unit may enlarge and display an image of the area of interest and display the plurality of enlarged radiological images so as to be switched.

The image display device according to the above-mentioned aspect of the invention may further include an area-of-interest setting unit that recognizes a lesion in the radiological image and setting an area including the lesion as the area of interest.

According to another aspect of the invention, there is provided an image display method including a step of displaying a plurality of radiological images on a display unit so as to be switched, a step of displaying, on the display unit, identification information for identifying a radiological image which is being displayed on the display unit and radiological images other than the radiological image which is being displayed, and a step of controlling a display position of the identification information.

In addition, a program may be provided which causes a computer to execute the image display method according to the above-mentioned aspect of the invention.

According to the invention, when a plurality of radiological images are displayed so as to be switched, the display position of the identification information for identifying a radiological image which is being displayed and radiological images other than the radiological image which is being displayed is controlled and the identification information is displayed on the display unit. Therefore, when the display position of the identification information is appropriately controlled such that the identification information is displayed in the vicinity of, for example, the area of interest, it is possible to identify the radiological image which is being displayed and the other radiological images, without moving the eyes, at the time a plurality of radiological images are displayed so as to be switched. As a result, it is possible to display a plurality of radiological images so as to be switched and to effectively perform comparative reading.

### BRIEF DESCRIPTION OF THE DRAWINGS

FIG. 1 is a block diagram schematically illustrating the structure of a medical image supporting system including an image display device according to a first embodiment of the invention.

FIG. 2 is a block diagram schematically illustrating the structure of the image display device according to the first embodiment.

FIG. 3 is a flowchart illustrating a process performed in the first embodiment.

FIG. 4A and FIG. 4B are diagrams illustrating the latest breast image and a past breast image of the same patient, respectively.

FIG. 5 is a diagram illustrating a breast image on which identification information is displayed.

FIG. 6 is a diagram illustrating a state in which the identification information is moved in the vicinity of an area of interest.

FIG. 7 is a diagram illustrating a state in which the latest breast image is displayed.

FIG. 8 is a diagram illustrating another example of the identification information according to the first embodiment.

FIG. 9A and FIG. 9B are diagrams illustrating another example of the identification information according to the first embodiment.

FIG. 10 is a block diagram schematically illustrating the structure of an image display device according to a second embodiment.

FIG. 11 is a diagram illustrating an area of interest set to a breast image.

FIG. 12 is a diagram illustrating a state in which both the breast image and an enlarged image of the area of interest are displayed.

FIG. 13 is a diagram illustrating a change in the color of a frame of a window for displaying the enlarged image.

FIG. 14 is a flowchart illustrating a process performed in a third embodiment.

FIG. 15 is a diagram illustrating tomographic images which are displayed so as to be switched in the third embodiment.

FIG. 16 is a diagram illustrating a state in which identification information is moved in the vicinity of the area of interest in the tomographic image.

FIG. 17 is a diagram illustrating the identification information according to the third embodiment.

FIG. 18 is a diagram illustrating another example of the identification information according to the third embodiment.

FIG. 19 is a diagram illustrating another example of the identification information according to the third embodiment.

FIG. 20 is a diagram illustrating a state in which the identification information is displayed in the vicinity of the area of interest and at the lower right corner of the tomographic image.

### DESCRIPTION OF THE PREFERRED EMBODIMENTS

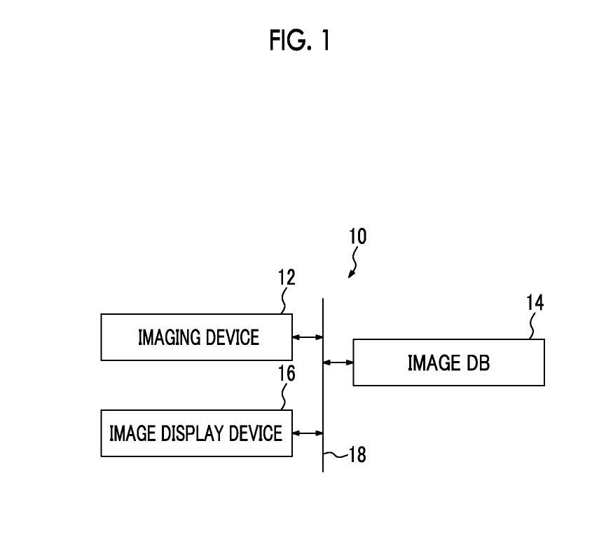

Hereinafter, embodiments of the invention will be described with reference to the drawings. FIG. 1 is a block diagram schematically illustrating the structure of a medical image supporting system to which an image display device according to a first embodiment of the invention is applied. As shown in FIG. 1, a medical image supporting system 10 is installed in, for example, medical facilities and includes an imaging device 12 that captures an image of a photographic subject and acquires a radiological image of the photographic subject, an image database (image DB) 14 that stores the radiological image captured by the imaging device 12, and an image display device 16 that includes a high-resolution monitor (not illustrated) and is used to read the radiological image. These devices are connected to each other by a network 18. The image display device 16 is an image reading terminal of the doctor.

In the first embodiment, the imaging device 12 is a mammography device that captures the image of the breast of a patient who is the photographic subject. The mammography device captures the image of the breast of the patient and acquires a breast image which is a radiological image of the breast. The image data of the acquired breast image is stored in the image database 14. At that time, supplementary information, such as a patient name and an imaging date, is stored in the image database 14 so as to be associated with the image data of the breast image.

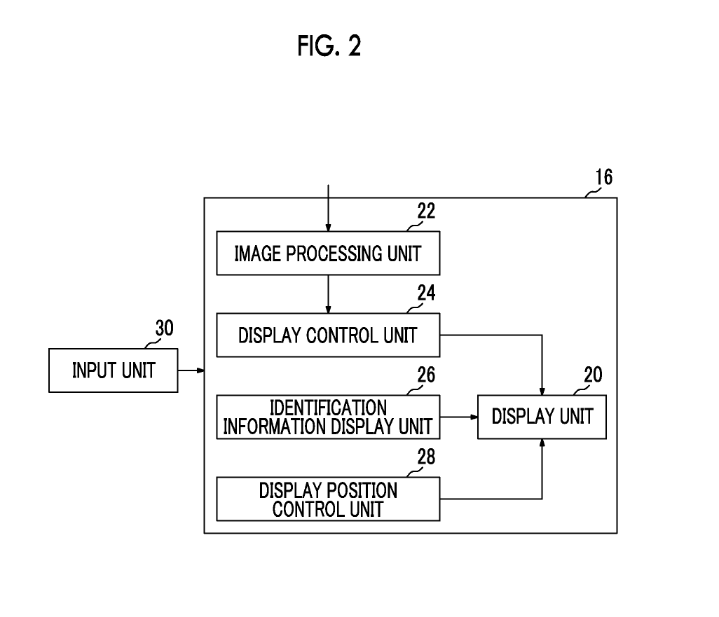

FIG. 2 is a block diagram schematically illustrating the structure of the image display device. As shown in FIG. 2, the image display device 16 according to the first embodiment includes a display unit 20, such as a CRT display or a liquid crystal display that displays images, an image processing unit 22 that performs image processing on at least one of two input image data items indicating the breast images of the same patient, which are captured at different dates and times, such that the positions of anatomic structures in the two breast images are substantially aligned with each other on the basis of the two image data items, thereby aligning the anatomic structures, a display control unit 24 that performs control such that the two aligned breast images are displayed on a screen of the display unit 20 so as to be switched on the basis of the two aligned image data items, an identification information display unit 26 that displays identification information for identifying the breast image, which is being displayed on the display unit 20, and the other breast image on the display unit 20, a display position control unit 28 that controls the display position of the identification information, and an input unit 30 such as a mouse or a keyboard.

The display unit 20, the image processing unit 22, the display control unit 24, the identification information display unit 26, the display position control unit 28, and the input unit 30 can be configured by a computer system such as a general personal computer.

It is assumed that the two breast images with different imaging dates and times which are used in the first embodiment are the latest breast image M0 at the present time and a past breast image M1 of the same patient. In addition, any of the left and right breasts may be an imaging target.

The display control unit 24 controls the display unit 20 such that the two breast images are displayed so as to be switched, in response to an instruction to switch the breast images displayed on the screen which is input from the input unit 30 by an operator. At the time of switching, for example, a display speed can be in the range of 1 to 5 frames per second.

The identification information display unit 26 displays identification information for identifying different imaging dates and times of the two breast images M0 and M1 on the display unit 20. In the first embodiment, the identification information is used to identify the latest breast image M0 and the past breast image M1. The identification information will be described below.

The display position control unit 28 controls the display position of the identification information such that the identification information is moved while being associated with a mouse cursor (hereinafter, simply referred to as a cursor) displayed on the display unit 20, in response to an input from the input unit 30. Therefore, when the cursor is moved by an input from the input unit 30, the identification information is moved while being associated with the cursor.

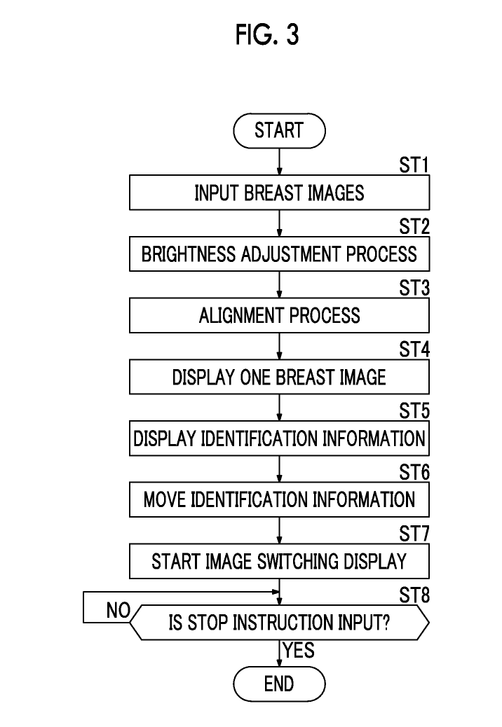

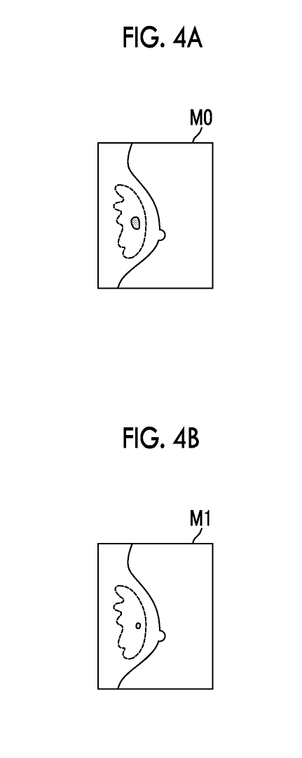

Next, a process performed in the first embodiment will be described. FIG. 3 is a flowchart illustrating the process performed in the first embodiment. First, the latest breast image M0 and the past breast image M1 of the same patient shown in FIGS. 4A and 4B are read from the image database 14 and are input to the image display device 16 (Step ST1).

When the breast images M0 and M1 are input, first, the image processing unit 22 performs a brightness adjustment process for each of the breast images M0 and M1 such that the brightness levels of the breast images M0 and M1 are substantially equal to each other (Step ST2). The reason why the brightness adjustment is performed is that, when there is a difference between the brightness levels of the images, an error may occur in the recognition of the structure of the chest when an alignment process, which will be described below, is performed or it may be difficult for the observer to see the displayed image. Specifically, any method, such as the method disclosed in JP2006-6435A which equalizes the maximum value and the minimum value of the pixel values and a method which equalizes the mean and the variance of the pixel values, can be used.

Then, the alignment process is performed for the breast images M0 and M1 such that the anatomic structures of the breast images M0 and M1 are substantially aligned with each other (Step ST3). Any method, such as a method using affine transformation which is disclosed in JP2006-6435A, can be used as a method for the alignment process. In addition, for example, the method disclosed in JP2002-65613A may be used which recognizes the position of the breast on the image using a known recognition technique and performs a warping process for one of two images such that the position of the side of the image of the pectoral muscle of the breast is aligned with the position of the nipple in the two images.

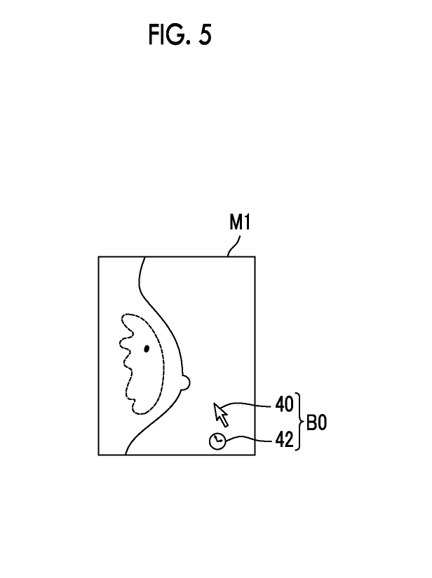

After the alignment process, the display control unit 24 displays one of the breast images M0 and M1 on the screen of the display unit 20 (Step ST4). In this embodiment, it is assumed that the past breast image M1 is displayed first. The identification information display unit 26 displays the identification information so as to be superimposed on the displayed breast image M1 (Step ST5). FIG. 5 is a diagram illustrating the breast image on which the identification information is displayed. When the past breast image M1 is displayed, as shown in FIG. 5, identification information B0 is a combination of a cursor 40 and a marker 42 indicating a clock.

The operator observes the displayed breast image M1 and moves the cursor 40 using the input unit 30 to move the identification information B0. Specifically, the operator moves the identification information B0 in the vicinity of the area of interest. Then, the display position control unit 28 moves the identification information B0 in the vicinity of the area of interest in association with the movement of the cursor 40 (Step ST6). The “area of interest” is a target to be compared with a plurality of images and indicates an area to which the user who observes the display unit 20 pays attention.

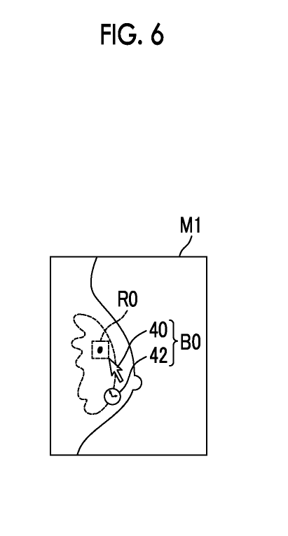

FIG. 6 is a diagram illustrating a state in which the identification information is moved in the vicinity of the area of interest. As shown in FIG. 6, the identification information B0 is moved and displayed in the vicinity of an area of interest R0 which is considered as a lesion in the breast image M1. Since the past breast image M1 is currently being displayed, the displayed identification information B0 is a combination of the cursor 40 and the marker 42 indicating a clock. The display position control unit 28 controls the display position of the identification information B0 such that the identification information B0 and the area of interest R0 fall within the range in which the identification information B0 and the area of interest R0 are simultaneously recognized by the user who observes the identification information B0 and the area of interest R0.

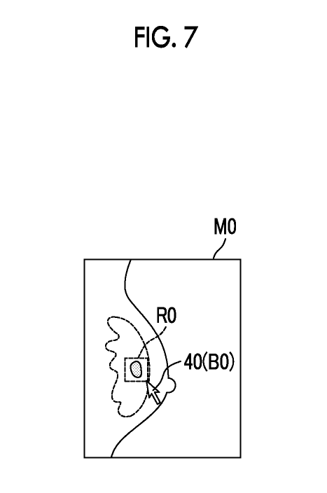

When the operator uses the input unit 30 to input an image switching display start instruction, the display control unit 24 starts to display the breast images M0 and M1 so as to be switched (Step ST7). That is, the display control unit 24 displays the breast images M0 and M1 on the screen of the display unit 20 so as to be repeatedly switched at a predetermined display speed (for example, about 1 to 5 frames per second). Therefore, the latest breast image M0 and the past breast image M1 are displayed so as to be switched. At that time, the position of the identification information B0 which is displayed in the vicinity of the area of interest R0 is not changed and different identification information items B0 for identifying the breast image M0 and the breast image M1 are displayed in order to identify the breast image which is being displayed. When the latest breast image M0 is displayed, as shown in FIG. 7, the identification information B0 does not include the marker 42 indicating the clock and includes only the cursor 40. Therefore, it is possible to identify whether the breast image which is being displayed is the latest breast image M0 or the past breast image M1 on the basis of whether the marker 42 indicating a clock is present in the identification information B0.

Before and while the images are displayed so as to be switched, for example, the display speed may be changed on the basis of information input from the input unit 30. In this case, the operator can adjust the display speed to a desired value at which the operator easily observes the images.

Then, the display control unit 24 starts to monitor whether an image switching display stop instruction is input from the input unit 30 (Step ST8). When the monitoring result in Step ST8 is “Yes”, the display control unit 24 stops the image switching display. In addition, the display control unit 24 may stop the image switching display after a predetermined period of time has elapsed from the start of the image switching display. Alternatively, the image switching display may be continuously performed only while the image switching display instruction is being input from the input unit 30.

According to the image switching display, the difference between the images, for example, the difference in characteristics in the area of interest R0 between the breast images M0 and M1 is conspicuous. Therefore, it is possible to easily observe an increase in the size of a calcified lesion which is a characteristic form of breast cancer.

In the above-described embodiment, the breast images M0 and M1 are displayed so as to be switched in response to an input switching display start instruction. However, the breast images M0 and M1 may be displayed so as to be switched whenever the operator inputs an image switching instruction. In this case, it is possible to freely control the display speed of the breast images M0 and M1 at the time when the switching instruction is input. Therefore, it is possible to adjust the display speed. In addition, it is possible to easily perform an operation of temporarily stopping the input of the switching instruction to interrupt the switching between the images and attentively observing one breast image.

As such, according to the first embodiment of the invention, when the breast images with different imaging dates and times are displayed so as to be switched, the display position of the identification information B0 for identifying the breast image which is being displayed and the other breast images is controlled and the identification information B0 is displayed on the display unit 20. Therefore, for example, the display position of the identification information B0 is appropriately controlled such that the identification information B0 is displayed in the vicinity of the area of interest R0. According to this structure, it is possible to identify the breast image which is being displayed and the other breast images, without moving the eyes from the area of interest R0, when the images are displayed so as to be switched. The identification information B0 and the area of interest R0 are arranged in the range in which the user who observes the display unit 20 can simultaneously recognize the identification information B0 and the area of interest R0. Specifically, the identification information B0 and the area of interest R0 are arranged in the range in which the user can recognize the identification information B0 and the area of interest R0, without moving the eyes. Therefore, it is possible to display the latest breast image M0 and the past breast image M1 so as to be switched and to effectively perform comparative reading over time.

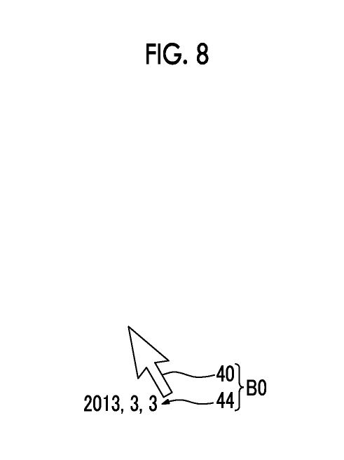

In the first embodiment, the identification information B0 includes only the cursor 40 or is a combination of the cursor 40 and the marker 42 indicating a clock. However, as shown in FIG. 8, letters 44 indicating the imaging date and time may be used as the identification information B0. In this case, while the latest breast image M0 is being displayed, the imaging date and time of the breast image M0 is displayed together with the cursor 40 as the identification information B0. While the past breast image M1 is being displayed, the imaging date and time of the breast image M1 is displayed together with the cursor 40 as the identification information B0. The identification information B0 may include supplementary information, such as a patient name and imaging conditions, in addition to the imaging date and time.

In the first embodiment, the latest breast image M0 and the past breast image M1 are identified on the basis of whether the marker 42 indicating the clock is present. However, the latest breast image M0 and the past breast image M1 may be identified on the basis of whether a marker with a specific shape or color is present or a difference between markers, instead of whether the marker 42 indicating a clock is present. For example, the marker may be displayed only on the past breast image or markers with different shapes or colors may be displayed on the latest breast image and the past breast image. In addition, the marker may not be used and the identification information B0 may include only the cursor 40. The color or shape of the cursor 40 may be changed to identify the latest breast image M0 and the past breast image M1.

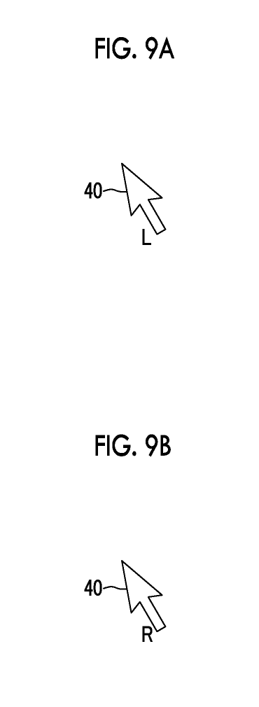

In the first embodiment, the latest breast image M0 and the past breast image M1 of the same patient are displayed so as to be switched. However, the left and right breast images of the same patient which are captured at the same time may be displayed so as to be switched. At that time, when the left breast image is displayed, for example, letter “L” may be used as the identification information B0 as shown in FIG. 9A. When the right breast image is displayed, letter “R” may be used as the identification information B0 as shown in FIG. 9B. This structure in which the identification information B0 is displayed in the vicinity of the area of interest in each of the left and right breast images makes it possible to easily recognize whether the breast image which is currently being displayed is the left breast image or the right breast image, without moving the eyes, when the left and right breast images are displayed so as to be switched.

In the first embodiment, the identification information B0 is moved in association with the movement of the cursor 40. However, the user may drag and drop the identification information B0 in the vicinity of the area of interest R0 using the input unit 30. In this case, the cursor may not be used and only the marker or the letter may be used as the identification information B0.

However, in the medical field, a computer aided diagnosis (hereinafter, referred to as CAD) system has been known which automatically detects an abnormal shadow in an image and displays the detected abnormal shadow so as to be highlighted. In the first embodiment, the operator sets the area of interest. However, the area of interest may be automatically set by the CAD. Next, this will be described as a second embodiment.

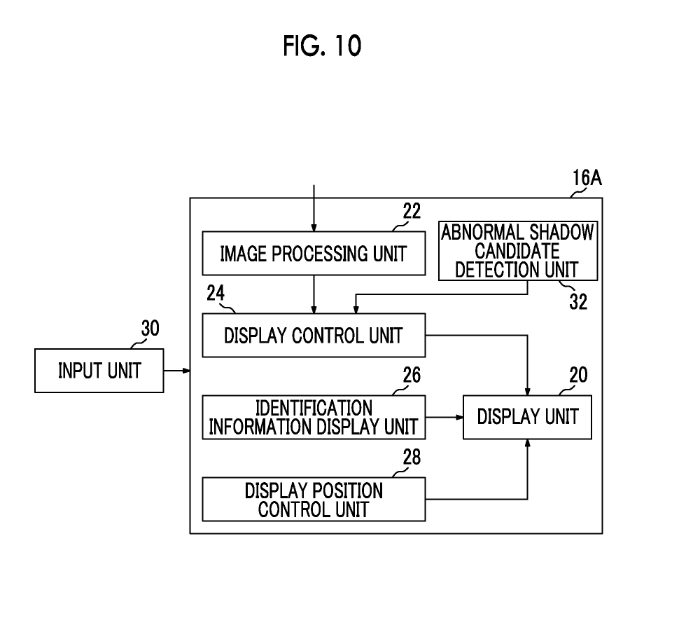

FIG. 10 is a block diagram schematically illustrating the structure of an image display device according to the second embodiment. In the second embodiment, the same structures as those in the first embodiment are denoted by the same reference numerals and the detailed description thereof will not be repeated. The second embodiment differs from the first embodiment in that an image processing device 16A is provided with an abnormal shadow candidate detection unit 32 that detects an abnormal shadow candidate in a breast image and an area of interest is set at the position of the abnormal shadow candidate detected by the abnormal shadow candidate detection unit 32.

As an abnormal shadow detection method of the abnormal shadow candidate detection unit 32, for example, the following methods have been known: a method that performs image processing for the breast image using an iris filter and performs threshold processing for an output value to automatically detect the candidates of a mass shadow (a form of an abnormal shadow) which is a form of a cancer (JP10-97624A); and a method that performs image processing using a morphology filter and performs threshold processing for an output value to automatically detect the candidates of a microcalcified shadow (a form of the abnormal shadow) which is another form of breast cancer (JP8-294479A).

As such, the abnormal shadow candidate detection unit 32 can detect an abnormal shadow candidate from the breast image. The abnormal shadow candidate detection unit 32 supplies the detection result to the display control unit 24. The abnormal shadow candidate detection unit 32 recognizes the abnormal shadow candidate as a lesion. The display control unit 24 sets an area in a predetermined range which surrounds the detected abnormal shadow candidate as an area of interest R0, on the basis of the detection result of the abnormal shadow candidate detection unit 32. The abnormal shadow candidate detection unit 32 and the display control unit 24 function as an area-of-interest setting unit.

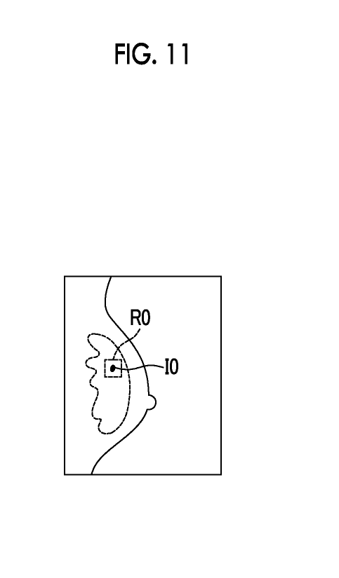

FIG. 11 is a diagram illustrating the area of interest R0 set in the breast image. As shown in FIG. 11, the area of interest R0 which surrounds an abnormal shadow candidate I0 detected by the abnormal shadow candidate detection unit 32 is set in the breast image. The operator moves identification information B0 in the vicinity of the area of interest R0 so as to be displayed in the vicinity of the area of interest R0, similarly to the first embodiment.

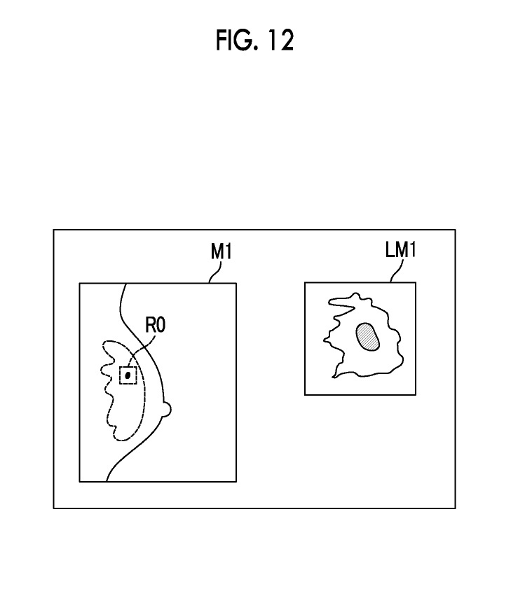

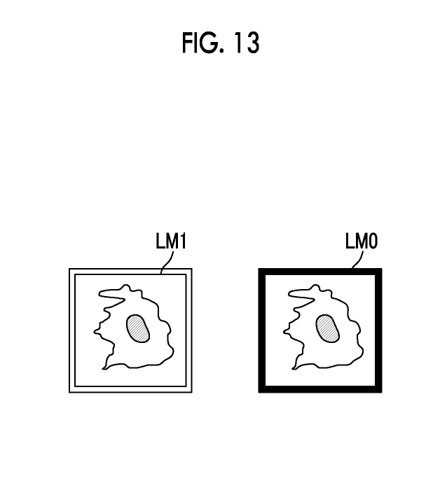

As shown in FIG. 12, in some cases, both the breast image and an enlarged image of the area of interest set in the breast image are displayed on the screen of the display unit 20. In FIG. 12, a breast image M1 and an enlarged image LM1 of the area of interest R0 set in the breast image M1 are displayed. As such, when both the breast image and the enlarged image of the area of interest R0 are displayed, it is possible to display only the enlarged image or both the enlarged image and the breast image so as to be switched. In this case, as shown in FIG. 13, in an enlarged image LM0 of the area of interest set in the latest breast image M0 and the enlarged image LM1 of the area of interest set in the past breast image M1, the color of a frame of a window on which the enlarged image is displayed can be changed to identify whether the enlarged image which is currently being displayed is included in the latest breast image or the past breast image. In FIG. 13, a difference in the color of the frame is represented by a difference in the fill of the frame. In addition, the line type of the frame may be changed to, for example, a solid line or a dashed line, instead of changing the color of the frame. In this case, the frame of the window is the identification information B0. Instead of changing the color or line type of the frame, the identification information B0 which includes only the cursor 40 or is a combination of the cursor 40 and a marker may be displayed so as to be superimposed on the enlarged image, similarly to the first embodiment.

In the first and second embodiments, the breast images are displayed so as to be switched. However, the images which are displayed so as to be switched may be the tomographic images of a plurality of tomographic planes for the same patient. Next, this will be described as a third embodiment.

In the third embodiment, an imaging device 12 is an imaging device that performs CT or tomosynthesis. In CT, a photographic subject is irradiated with radiation in a plurality of different directions, the radiological images of the photographic subject are captured, and the tomographic images of the photographic subject is generated on the basis of information about a plurality of acquired radiological images. In tomosynthesis, a radiation source is moved in parallel to a radiation detector or is moved in a circle or an ellipse, according to the characteristics of the imaging device or necessary tomographic images, the images of the subject are captured at a plurality of irradiation positions with different irradiation angles to acquire a plurality of radiological images, and the radiological images are reconstructed by a back projection method, such as a simple back projection method or a filter back projection method, to generate tomographic images. The generated tomographic images are stored in the image database 14.

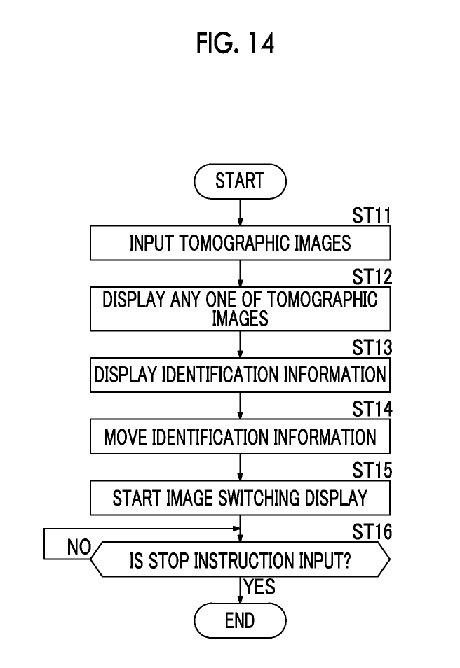

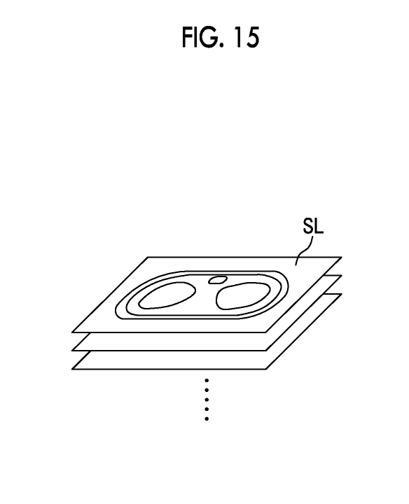

Next, a process performed in the third embodiment will be described. FIG. 14 is a flowchart illustrating the process performed in the third embodiment. First, a plurality of tomographic images SL of the same patient shown in FIG. 15 are read from the image database 14 and are then input to the image display device 16 (Step ST11). In general, a brightness adjustment process is performed for the tomographic images SL such that the brightness levels of the tomographic images SL are substantially equal to each other. Since the tomographic images indicate different cross sections, alignment is not needed. Therefore, in the third embodiment, after images are input to the image display device 16, the brightness adjustment process and the alignment process are omitted.

When the tomographic images SL are input, the display control unit 24 displays the tomographic image of a reference tomographic plane on the screen of the display unit 20 (Step ST12). In the third embodiment, it is assumed that the tomographic image of the tomographic plane which is perpendicular to the body axis of the patient is used and the tomographic images are displayed in the order from the tomographic plane close to the head of the patient to the tomographic plane away from the head of the patient so as to be switched. Therefore, it is assumed that the reference tomographic plane is the tomographic plane closest to the head. Hereinafter, the tomographic plane which is close to the head is referred to as an upper tomographic plane and the tomographic plane which is away from the head is referred to as a lower tomographic plane.

The identification information display unit 26 displays identification information so as to be superimposed on the displayed tomographic image (Step ST13). The identification information in the third embodiment will be described below.

The operator observes the displayed tomographic image and uses the input unit 30 to move the identification information in the vicinity of the area of interest. Then, the display position control unit 28 moves the identification information (Step ST14).

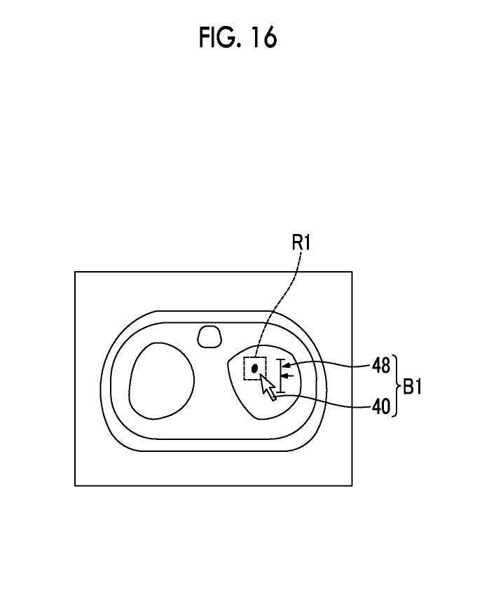

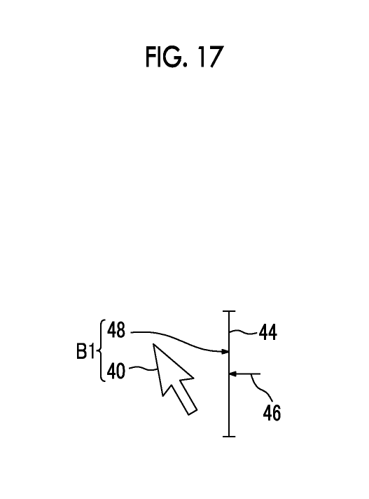

FIG. 16 is a diagram illustrating a state in which the identification information is moved in the vicinity of the area of interest in the tomographic image. As shown in FIG. 16, identification information B1 is moved and displayed in the vicinity of an area of interest R1 which is considered as a lesion in the tomographic image. FIG. 17 is an enlarged view illustrating the identification information B1 in the third embodiment. In the third embodiment, the identification information B1 is a combination of the cursor 40 and a slide bar 48 in which an arrow 46 indicating the position of the tomographic plane of the tomographic image which is being displayed is assigned to a scale 44 that extends in the vertical direction. The display position control unit 28 controls the display position of the identification information B1 such that the identification information B1 and the area of interest R1 fall in the range in which the user who observes the identification information B1 and the area of interest R1 recognizes the identification information B1 and the area of interest R1 at the same time.

When the operator inputs an image switching display start instruction using the input unit 30, the display control unit 24 starts tomographic image switching display (Step ST15). That is, the display control unit 24 sequentially displays a plurality of tomographic images on the screen of the display unit 20 so as to be switched at the same predetermined display speed as that in the first embodiment. Then, a plurality of tomographic images are sequentially displayed so as to be switched while the tomographic planes are changed from the top to the bottom.

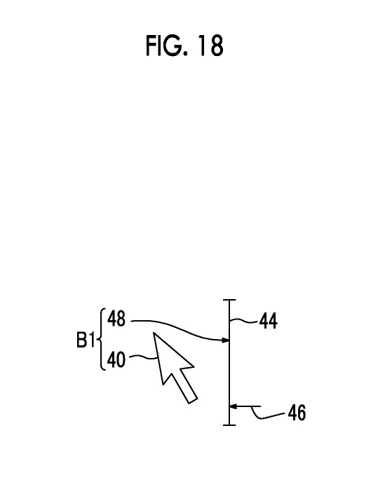

At that time, the position of the identification information B1 displayed in the vicinity of the area of interest is not changed. In addition, in the identification information B1, the position of the arrow 46 in the slide bar 48 is changed depending on the position of the tomographic plane of the tomographic image which is being displayed. For example, when the tomographic image which is being displayed indicates substantially the middle tomographic plane among the tomographic images SL, the identification information B1 in which the arrow 46 is assigned substantially to the middle of the scale 44 is displayed as shown in FIG. 17. In contrast, when the tomographic image which is being displayed indicates the lower tomographic plane, the identification information B1 in which the arrow 46 is assigned to the lower side of the scale 44 is displayed as shown in FIG. 18.

Before and while the images are displayed so as to be switched, for example, the display speed may be changed on the basis of information input from the input unit 30. In this case, the operator can adjust the display speed to a desired value at which the operator easily observes the images. In addition, the tomographic planes may be sequentially changed and the tomographic images may be displayed. After the tomographic image of the lowest tomographic plane is displayed, the process may return to the uppermost tomographic plane and the tomographic images may be displayed so as to be switched. The display direction may be reversed from the lowest tomographic plane to the upper tomographic plane and the tomographic images may be displayed so as to be switched. In addition, the display direction of the tomographic planes may be changed from the top to the bottom or from the bottom to the top by an input from the input unit 30 during image switching display.

Then, the display control unit 24 starts to monitor whether an image switching display stop instruction is input from the input unit 30 (Step ST16). When the monitoring result in Step ST16 is “Yes”, the display control unit 24 ends the image switching display. The display control unit 24 may end the image switching display after a predetermined period of time has elapsed from the start of the image switching display. Alternatively, the image switching display may be continuously performed only while the image switching display instruction is being input from the input unit 30.

According to the image switching display, the difference between the images, for example, the difference in characteristics in the area of interest between the tomographic images is conspicuous. Therefore, it is possible to easily observe the spreading of a tumor mass in a direction perpendicular to the tomographic plane.

In the above-described embodiment, the tomographic images are displayed so as to be switched in response to an input switching display start instruction. However, the tomographic images to be displayed may be switched whenever the operator inputs an image switching instruction. In this case, it is possible to freely control the display speed of the tomographic images at the time when the switching instruction is input. Therefore, it is possible to adjust the display speed. In addition, it is possible to easily perform an operation of temporarily stopping the input of the switching instruction to interrupt the switching between the images and attentively observing one tomographic image.

As such, according to the third embodiment of the invention, when the tomographic images are displayed so as to be switched, the display position of the identification information B1 for identifying the tomographic image which is being displayed and the other tomographic images is controlled and the identification information B1 is displayed on the display unit 20. Therefore, for example, the display position of the identification information B1 is appropriately controlled such that the identification information B1 is displayed in the vicinity of the area of interest R1. According to this structure, it is possible to identify the tomographic image which is being displayed and the other tomographic images, without moving the eyes from the area of interest R1. The identification information B1 and the area of interest R1 are arranged in the range in which the user who observes the display unit 20 can simultaneously recognize the identification information B1 and the area of interest R1. Specifically, the identification information B1 and the area of interest R1 are arranged in the range in which the user can recognize the identification information B1 and the area of interest R1, without moving the eyes. Therefore, it is possible to display the tomographic images so as to be switched and to effectively perform comparative reading.

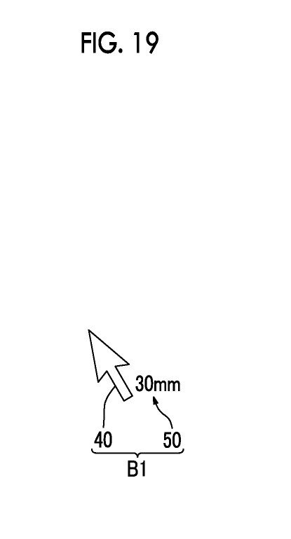

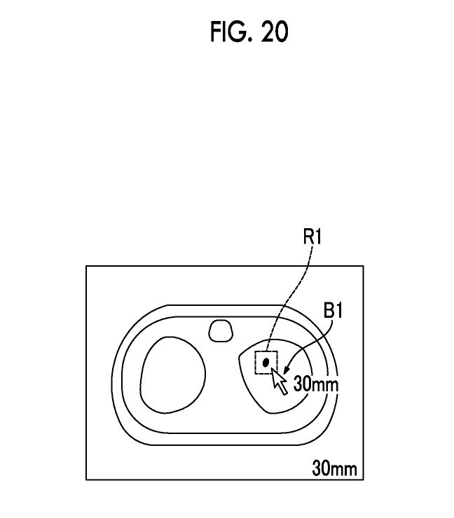

In the third embodiment, the identification information B1 is a combination of the cursor 40 and the slide bar 48. However, for example, as shown in FIG. 19, the identification information B1 may include letters 50 (here 30 mm) indicating the distance from a reference tomographic plane (for example, a tomographic plane closest to the head) in the tomographic plane indicated by the tomographic image which is being displayed. In this case, as shown in FIG. 20, the identification information B1 is displayed in the vicinity of the area of interest R1. However, the distance from the reference tomographic plane (for example, the tomographic plane closest to the head) in the tomographic plane indicated by the tomographic image which is being displayed may be also displayed at the lower right corner of the tomographic image.

In the first to third embodiments, the identification information is moved in the vicinity of the area of interest in response to an input from the input unit 30. However, the identification information may be automatically moved (displayed) to the set area of interest.

The invention is not limited to the above-mentioned examples and various improvements and modifications of the invention may be made without departing from the scope and spirit of the invention.

Next, the operation and effects of preferred aspects of the invention will be described.

A plurality of radiological images of the same photographic subject are captured at different dates and times. When the radiological images with different imaging dates and times are displayed so as to be switched, identification information for identifying the radiological images with different imaging dates and times is displayed. Therefore, it is possible to identify the radiological image which is currently being displayed and the other radiological images, without moving the eyes. As a result, it is possible to display the radiological images of the same photographic subject captured at different dates and times so as to be switched and to effectively perform comparative reading.

A plurality of radiological images are the tomographic images of a plurality of tomographic planes for the same photographic subject. When the tomographic images of different tomographic planes are displayed so as to be switched, the identification information for identifying the tomographic images of different tomographic planes is displayed. Therefore, it is possible to identify the tomographic image of a tomographic plane corresponding to the radiological image which is currently being displayed, without moving the eyes. As a result, it is possible to display the tomographic images of the same photographic subject so as to be switched and to effectively perform comparative reading.

In addition, the area of interest is designated in a plurality of radiological images and the identification information is displayed in the vicinity of the area of interest. Therefore, it is possible to identify a plurality of radiological images, without moving the eyes from the area of interest. As a result, it is possible to effectively perform comparative reading for the area of interest.

The area of interest is enlarged and displayed and a plurality of enlarged radiological images are displayed so as to be switched. Therefore, it is possible to effectively perform comparative reading for the area of interest.

A lesion in the radiological image is recognized and an area including the lesion is designated as the area of interest. Therefore, it is possible to effectively perform comparative reading for the lesion.

### EXPLANATION OF REFERENCES

10: medical image supporting system
12: imaging device
14: image database
16: image display device
20: display unit
22: image processing unit
24: display control unit
26: identification information display unit
28: display position control unit
30: input unit
32: abnormal shadow candidate detection unit

What is claimed is:

1. An image display device comprising:
a display control unit that displays a plurality of radiological images on a display unit so as to be switched;
an identification information display unit that displays, on the display unit, identification information for identifying a radiological image which is being displayed on the display unit and radiological images other than the radiological image which is being displayed; and
a display position control unit that controls a display position of the identification information.

2. The image display device according to claim 1,
wherein the plurality of radiological images are radiological images of the same photographic subject which are captured at different dates and times,
the display control unit displays the radiological images with different imaging dates and times so as to be switched, and
the identification information display unit displays identification information which can identify the imaging date and time.

3. The image display device according to claim 1,
wherein the plurality of radiological images are tomographic images of a plurality of tomographic planes for the same photographic subject,
the display control unit displays the tomographic images of different tomographic planes so as to be switched, and
the identification information display unit displays identification information which can identify the tomographic planes.

4. The image display device according to claim 1,
wherein the display position control unit displays the identification information in the vicinity of an area of interest in the radiological image.

5. The image display device according to claim 2,
wherein the display position control unit displays the identification information in the vicinity of an area of interest in the radiological image.

6. The image display device according to claim 3,
wherein the display position control unit displays the identification information in the vicinity of an area of interest in the radiological image.

7. The image display device according to claim 4,
wherein the display control unit enlarges and displays an image of the area of interest and displays the plurality of enlarged radiological images so as to be switched.

8. The image display device according to claim 5,
wherein the display control unit enlarges and displays an image of the area of interest and displays the plurality of enlarged radiological images so as to be switched.

9. The image display device according to claim 6,
wherein the display control unit enlarges and displays an image of the area of interest and displays the plurality of enlarged radiological images so as to be switched.

10. The image display device according to claim 4, further comprising:
an area-of-interest setting unit that recognizes a lesion in the radiological image and setting an area including the lesion as the area of interest.

11. The image display device according to claim 5, further comprising:
an area-of-interest setting unit that recognizes a lesion in the radiological image and setting an area including the lesion as the area of interest.

12. The image display device according to claim 6, further comprising:
an area-of-interest setting unit that recognizes a lesion in the radiological image and setting an area including the lesion as the area of interest.

13. The image display device according to claim 7, further comprising:
an area-of-interest setting unit that recognizes a lesion in the radiological image and setting an area including the lesion as the area of interest.

14. The image display device according to claim 8, further comprising:
an area-of-interest setting unit that recognizes a lesion in the radiological image and setting an area including the lesion as the area of interest.

15. The image display device according to claim 9, further comprising:
an area-of-interest setting unit that recognizes a lesion in the radiological image and setting an area including the lesion as the area of interest.

16. An image display method using the image display device according to claim 1, comprising:
a step of displaying a plurality of radiological images on a display unit so as to be switched;
a step of displaying, on the display unit, identification information for identifying a radiological image which is being displayed on the display unit and radiological images other than the radiological image which is being displayed; and
a step of controlling a display position of the identification information.
